(19) United States
(12) Patent Application Publication
(10) Pub. No.: US 2014/0272478 A1
(43) Pub. Date: Sep. 18, 2014

(54) METHODS AND SYSTEMS FOR MITIGATING PRESSURE DIFFERENTIALS IN AN ENERGY STORAGE DEVICE

(71) Applicants: Jon K. West, Gainesville, FL (US); Nelson Citta, Lake City, FL (US); Myles Citta, High Springs, FL (US); Joshua Gordon, Ocala, FL (US)

(72) Inventors: Jon K. West, Gainesville, FL (US); Nelson Citta, Lake City, FL (US); Myles Citta, High Springs, FL (US); Joshua Gordon, Ocala, FL (US)

(21) Appl. No.: 13/836,094

(22) Filed: Mar. 15, 2013

(51) Int. Cl. H01G 9/12; H01M 2/12

(52) U.S. Cl. CPC H01G 9/12; H01M 2/1223
USPC 429/50; 429/53; 361/521

(57) ABSTRACT

Apparatus and methods are provided for energy storage devices capable of mitigating the pressure differentials between adjacent bi-polar units using a pressure equalization valve at a projection from a substrate of a bi-polar unit, which prevents the pressure equalization valve from being submerged by free liquid in the unit.

### BACKGROUND

Bi-polar energy storage devices (“ESDs”) provide an increased discharge rate and a higher voltage potential between their external connectors than standard wound or prismatic cells, and are therefore in high demand for certain applications. A typical bi-polar ESD includes multiple cells arranged in a stack. Specifically, the cells are stacked such that a negative plate of one cell becomes the positive plate of the next cell in the stack. During operation of the bi-polar ESD, a pressure differential may develop between adjacent cells. Accordingly, it would be desirable to provide an ESD that mitigates the pressure differentials that may develop between adjacent cells.

### SUMMARY

Apparatus and methods are provided for bi-polar energy storage devices (“ESDs”) with the ability to mitigate the pressure differentials between adjacent cells. In particular, the apparatus and methods provided mitigate the pressure differentials between adjacent bi-polar electrode units (“BPUs”) using a pressure equalization valve at a projection from a substrate of a BPU cell.

For example, a hydrophobic pressure equalization valve on a substrate may allow gas to transfer between adjacent cells to mitigate any pressure differentials between the adjacent cells, while preventing the electrolyte from passing through the substrate. However, in some circumstances, free liquid may develop in the electrolyte of the cell. If the free liquid submerges the pressure equalization valve, the gas may not be able to traverse the substrate. Accordingly, in certain embodiments, a pressure equalization valve is located at a projection extending from the substrate, which prevents the pressure equalization valve from being submerged even in the presence of free liquid within the BPU cell.

In certain embodiments, the projection may be offset from a substrate or the inner boundaries of the cell, which prevents the pressure equalization valve from being submerged by free liquid when the ESD is in multiple orientations. For example, the ESD may be oriented in a first position. In such a case, gravity may cause free liquid to pool about the circumference of the projection as the projection extends in a perpendicular direction. The height of the projection ensures that the pressure equalization valve is above the liquid level of the free liquid.

In certain embodiments, the ESD may be oriented in a second position (e.g., perpendicular to the first position). In such a case, gravity may cause the free liquid to pool in the direction parallel to the one in which the projection extends, negating any advantage the height of the projection provided. To ensure that the pressure equalization valve is above the liquid level of the free liquid in the second position, the pressure equalization valve may be offset in a direction perpendicular to the liquid level of the free liquid.

According to one aspect, a system for mitigating pressure differentials between cells in an ESD includes a substrate, a projection from the substrate, and a pressure equalization valve, located at the projection, a threshold distance from the substrate. In certain implementations, the threshold distance is such that the pressure equalization valve located at the projection is not submerged by free liquid while the ESD is in a first position. For example, the threshold distance is above the liquid level of any free liquid that may have formed in the ESD.

In certain implementations, the system for mitigating pressure differentials between cells in an ESD includes an active material and the projection is offset from the active material. In certain implementations, the ESD includes a hardstop and the projection is offset from the hardstop. The projection may also be offset from the hardstop a threshold distance, and, in certain implementations, the threshold distance the projection is offset from the hardstop is such that the pressure equalization valve located at the projection is not submerged by free liquid while the ESD is in a second position. For example, the threshold distance may be a distance away from the hardstop such that the pressure equalization valve is above the liquid level of any free liquid that may have formed in the ESD.

In certain implementations, the projection may have various shapes (e.g., conical, polyhedral, etc.), which may aid in mitigating pressure differentials between cells. The ESD may include a connection area between the projection and the substrate, which may depend on the shape of the projection. For example, if the shape of the projection is polyhedral, the connection between the projection and the substrate may include a first length in a first direction along the substrate and a second length, different than the first length, in a second direction.

In certain implementations, the ESD includes a hydrophobic element located at the pressure equalization valve. For example, the hydrophobic element may be gas permeable, but it may be impermeable to liquid. In certain implementations, the pressure equalization valve may be located at a surface of the projection that is substantially parallel to the surface of the substrate. For example, the projection may extend in a direction away from the substrate, and the pressure equalization valve may be accessible via a surface, substantially parallel to the substrate, at the end on the projection.

In certain implementations, the ESD includes an aperture located at the projection for receiving the pressure equalization valve. For example, the pressure equalization valve may reside in an aperture at the substrate. The aperture, and consequently the pressure equalization valve, may have various diameters. For example, the aperture may have a diameter between 1 micron and 100 microns, 1 micron and 1000, or 1 micron and 10000 microns.

According to one aspect, pressure differentials between cells in an ESD are mitigated by allowing gas to transfer between adjacent cells through a pressure equalization valve located at a projection located at a substrate and preventing a liquid level from submerging the pressure equalization valve located a threshold distance from the substrate. In certain implementations, mitigating the pressure differential may include containing the gas at least in part by a boundary (e.g., a hardstop), wherein the projection is offset from the boundary. The projection may be offset from the boundary a threshold distance, and the threshold distance the projection is offset from the boundary is such that the pressure equalization valve located at the projection is not submerged by free liquid while the ESD is in a second position.

In certain implementations, mitigating the pressure differential include preventing electrolyte from transferring through the pressure equalization valve. In certain implementations, mitigating the pressure differential includes allowing the gas to traverse the substrate though an aperture located at the projection for receiving the pressure equalization valve. In certain implementations, the aperture may have a diameter between 1 micron and 10000 microns.

According to one aspect, a system for mitigating pressure differentials between cells in an ESD includes a transfer means for allowing gas to transfer between cells separated by a substrate and a location means for locating said transfer means a threshold distance from the substrate. In certain implementations, the threshold distance is such that the transfer means located at the location means is not submerged by free liquid while the ESD is in a first position. For example, the threshold distance is above the liquid level of any free liquid that my have formed in the ESD.

In certain implementations, the system for mitigating pressure differentials between cells in an ESD includes an active material and the location means is offset from the active material. In certain implementations, the ESD includes a containment means that forms a boundary perpendicular to the substrate and the location means is offset from the containment means. The location means may also be offset from the containment means a threshold distance, and, in certain implementations, the threshold distance the location means is offset from the containment means is such that the transfer means located at the projection is not submerged by free liquid while the ESD is in a second position. For example, the threshold distance may be a distance away from the containment means such that the transfer means is above the liquid level of any free liquid that may have formed in the ESD.

In certain implementations, the location means may have various shapes (e.g., conical, polyhedral, etc.), which may aid in mitigating pressure differentials between cells. The ESD may include a connection area between the location means and the substrate, which may depend on the shape of the location means. For example, if the shape of the location means is polyhedral, the connection between the location means and the substrate may include a first length in a first direction along the substrate and a second length, different than the first length, in a second direction.

In certain implementations, the ESD includes a hydrophobic element located at the transfer means. For example, the hydrophobic element may be gas permeable, but it may be impermeable to liquid. In certain implementations, the transfer means may be located at a surface of the location means that is substantially parallel to the surface of the substrate. For example, the location means may extend in a direction away from the substrate, and the transfer means may be accessible via a surface, substantially parallel to the substrate, at the end on the projection.

In certain implementations, the ESD includes an aperture located at the location means for receiving the transfer means. For example, the transfer means may reside in an aperture at the substrate. The aperture, and consequently the transfer means, may have various diameters. For example, the aperture may have a diameter between 1 micron and 100 microns, 1 micron and 1000, or 1 micron and 10000 microns.

Variations and modifications of these embodiments will occur to those of skill in the art after reviewing this disclosure. The foregoing features and aspects may be implemented, in any combination and subcombination (including multiple dependent combinations and subcombinations), with one or more other features described herein. The various features described or illustrated herein, including any components thereof, may be combined or integrated in other systems. Moreover, certain features may be omitted or not implemented.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows a schematic cross-sectional view of an illustrative structure of a BPU featuring projections;

FIG. 2 shows a schematic cross-sectional view of an illustrative structure of a stack of BPUs featuring projections;

FIG. 3 shows a schematic cross-sectional view of an illustrative structure of a stacked bi-polar ESD;

FIG. 4 shows a schematic cross-sectional view of an illustrative BPU featuring a projection and a pressure equalization valve in a first orientation;

FIG. 5 shows a schematic cross-sectional view of an illustrative BPU featuring a projection and a pressure equalization valve in a second orientation;

FIG. 6 shows a schematic view of an illustrative projection and a pressure equalization valve featuring a conical shape;

FIG. 7 shows a schematic view of an illustrative projection and a pressure equalization valve featuring a polyhedral shape;

FIG. 8 shows a schematic view of an illustrative projection and a plurality of pressure equalization valves; and

FIG. 9 shows a schematic cross-sectional view of an illustrative structure of a stacked bi-polar ESD, in which a pressure equalization valve is located in a through hole of a hardstop.

### DETAILED DESCRIPTION

Apparatus and methods are provided for energy storage devices (“ESDs”) capable of mitigating the pressure differentials between adjacent bi-polar electrode units (“BPUs”) and are described below with reference to FIGS. 1-8. ESDs include, for example, batteries, capacitors, or any other suitable electrochemical energy or power storage devices which may store and/or provide electrical energy or current. It will be understood that, while certain embodiments are described herein in the context of a stacked bi-polar ESD, the concepts discussed are applicable to any intercellular electrode configuration including, but not limited to, parallel plate, prismatic, folded, wound and/or bi-polar configurations, any other suitable configuration, or any combinations thereof.

Various types of ESDs with sealed cells in a stacked formation have been developed that are able to provide higher discharge rates and higher voltage potentials between external connectors than that of standard wound or prismatic ESDs, and are therefore in high demand for certain applications. Certain types of these ESDs with sealed cells in a stacked formation have been developed to generally include a stack of independently sealed pairs of mono-polar electrode units (MPUs). Each of these MPUs is provided with either a positive active material electrode layer or a negative active material electrode layer coated on a first side of a current collector. An MPU with a positive active material electrode layer (i.e., a positive MPU) and an MPU with a negative active material electrode layer (i.e., a negative MPU) has an electrolyte layer therebetween for electrically isolating the current collectors of those two MPUs. The current collectors of this pair of positive and negative MPUs, along with the active material electrode layers and electrolyte therebetween, are sealed as a single cell or cell segment. An ESD that includes a stack of such cells, each having a positive MPU and a negative MPU, shall be referred to herein as a “stacked mono-polar” ESD.

The side of the current collector of the positive MPU not coated with an electrode layer in a first cell is electrically coupled to the side of the current collector of the negative MPU not coated with an electrode layer in a second cell, such that the first and second cells are in a stacked formation. The series configuration of these cell segments in a stack may cause the voltage potential to be different between current collectors. However, if the current collectors of a particular cell contact each other or if the common electrolyte of the two MPUs in a particular cell is shared with any additional MPU in the stack, the voltage and energy of the ESD would fade (i.e., discharge) quickly to zero. Therefore, a stacked mono-polar ESD independently seals the electrolyte of each of its cells from each of its other cells.

Other types of ESDs with sealed cells in a stacked formation have been developed to generally include a series of stacked BPUs. Each of these BPUs is provided with a positive active material electrode layer and a negative active material electrode layer coated on opposite sides of a current collector. Any two BPUs can be stacked on top of one another with an electrolyte layer provided between the positive active material electrode layer of one of the BPUs and the negative active material electrode layer of the other one of the BPUs for electrically isolating the current collectors of those two BPUs. The current collectors of any two adjacent BPUs, along with the active material electrode layers and electrolyte therebetween, may also be a sealed single cell or cell segment. An ESD that includes a stack of such cells, each having a portion of a first BPU and a portion of a second BPU, shall be referred to herein as a “stacked bi-polar” ESD.

While the positive side of a first BPU and the negative side of a second BPU may form a first cell, the positive side of the second BPU may likewise form a second cell with the negative side of a third BPU or the negative side of a negative MPU, for example. Therefore, an individual BPU may be included in two different cells of a stacked bi-polar ESD. The series configuration of these cells in a stack may cause the voltage potential to be different between current collectors. However, if the current collectors of a particular cell contact each other or if the common electrolyte of the two BPUs in a first cell is shared with any other cell in the stack, the voltage and energy of the ESD would fade (i.e., discharge) quickly to zero.

Stacked bi-polar ESDs may use flat electrode plates. By using flat plates and isolating them by use of an edge seal, cells in a stacked electrochemical ESD may operate substantially independently. As the independent cells are charged and discharged, slight pressure differences may develop between adjacent cells. If the pressure difference between the adjacent cells exceeds a few pounds per square inch, then the flat electrode may deflect from the first cell towards the second cell. This deflection may strain the separator material of the second cell, creating a “hot spot” where a short circuit may develop. Because the physical components and the chemistry of individual cells will generally be slightly different from one another, pressure differentials between cells will generally exist.

FIG. 1 shows an illustrative “flat plate” bi-polar electrode unit or BPU 100. Flat plate structures for use in stacked cell ESDs are discussed in more detail in Ogg et al. U.S. Pat. No. 7,794,877, issued Sep. 14, 2010, and Ogg et al. U.S. patent application Ser. No. 12/069,793, filed Feb. 12, 2008, both of which are hereby incorporated by reference herein in their entireties. BPU 100 may include a positive active material electrode layer 102 that may be provided on a first side of an impermeable conductive substrate 106, and a negative active material electrode layer 104 that may be provided on the other side of impermeable conductive substrate 106.

It will be understood that the bi-polar electrode may have any suitable shape or geometry. For example, a “flat plate” BPU may alternatively be a “dish-shaped” electrode. This may reduce pressures that may develop during operation of a bi-polar ESD. Dish-shaped and pressure equalizing electrodes are discussed in more detail in West et al. U.S. patent application Ser. No. 12/258,854, filed Oct. 27, 2008, which is hereby incorporated by reference herein in its entirety.

In certain embodiments, a BPU includes a pressure equalization valve. The pressure equalization valve may use mechanical or chemical properties to mitigate the pressure differentials between adjacent cells. For example, the pressure equalization valve may be a disk made from any suitable material such as a non-conductive polymer, rubber, any other suitable material, or any combination thereof and may be resistant to chemical corrosion (e.g., due to exposure to electrolyte), including, but not limited to, poly-vinyl, poly-sulfone, neoprene, or any combination thereof, for example. The pressure equalization valve may additionally or alternatively include a gas permeable membrane utilizing chemical properties rather than mechanical properties to allow gas to traverse a substrate, while preventing electrolyte from also traversing the substrate. Pressure equalization valves are also discussed in more detail in West et al. U.S. patent application Ser. No. 12/258,854, which, as noted above, is hereby incorporated by reference herein in its entirety.

FIG. 2 shows a schematic cross-sectional view of a structure of a stack of BPUs (see, e.g., BPU 100 of FIG. 1). For example, multiple BPUs 202 may be stacked substantially vertically into a stack 200, with an electrolyte layer 210 that may be provided between two adjacent BPUs 202, such that positive electrode layer 204 of one BPU 202 may be opposed to negative electrode layer 208 of an adjacent BPU 202 via electrolyte layer 210. Each electrolyte layer 210 may include a separator (not shown) that may hold an electrolyte. The separator may electrically separate the positive electrode layer 204 and negative electrode layer 208 adjacent thereto, while allowing ionic transfer between the electrode units described in more detail below.

With continued reference to the stacked state of BPUs 202 in FIG. 2, for example, the components included in positive electrode layer 204 and substrate 206 of a first BPU 202, the negative electrode layer 208 and substrate 206 of a second BPU 202 adjacent to the first BPU 202, and the electrolyte layer 210 between the first and second BPUs 202 shall be referred to herein as a single “cell” or “cell segment.” Each impermeable substrate 206 of each cell segment (e.g., cell segment 212a) may be shared by the applicable adjacent cell segment (e.g., cell segment 212b).

In order to prevent electrolyte of a first cell segment from combining with the electrolyte of another cell segment, hardstops, gaskets, or other seals (not shown) may be stacked with the electrolyte layers between adjacent electrode units to seal electrolyte within its particular cell segment. The hardstops, gaskets, or other seals may be any suitable compressible or incompressible solid or viscous material, any other suitable material, or combinations thereof, for example, that may interact with adjacent electrode units of a particular cell to seal electrolyte therebetween. The hardstops, gaskets, or other seals may be continuous and closed and may seal electrolyte between the hardstop and the adjacent electrode units of that cell (i.e., the BPUs or the BPU and MPU adjacent to that hardstop or other seal) creating an “inner boundary.” The hardstops, gaskets, or other seals may provide appropriate spacing between the adjacent electrode units of that cell, for example.

FIG. 2 also includes a plurality of projections from the substrate 206. The projections extend from the surface of the substrate such that a pressure equalization valve located at the projection is not submerged in the presence of free liquid. Under normal conditions, the ESD should be free of large quantities of free liquid within a cell segment. However, during formation and stabilization (e.g., near the creation of the ESD) of the electrochemistry within the cell, large quantities of free liquid may exist. After formation and stabilization each cell segment (e.g., cell segment 212a, 212b, and 212c) may not have excess electrolyte, and electrolyte should exist as droplets and not free liquid for the remainder of the lifetime of the ESD.

However, prior to formation and stabilization, large quantities of free liquid may exist. Furthermore, if the amount of free liquid is great enough, a pressure equalization valve located at the substrate may be submerged. In such cases, gas may not be able to transfer between cells of the ESD, and the pressure differential may not be mitigated.

In the embodiment shown in FIG. 2, stack 200 includes a plurality of projections (e.g., projection 214, projection 216, projection 218, projection 220, projection 222, and projection 224). Each projection extends away from the substrate (e.g., substrate 206) such that a pressure equalization valve located at the projection is not submerged even in the presence of large quantities of free liquid. As shown in FIG. 2, a projection may include numerous shapes and sizes such as conical (e.g., projection 214 and projection 216), elliptical (projection 224), polyhedral (e.g., projection 218 and projection 222), spherical (e.g., projection 220), and/or any other suitable shape or combinations thereof.

In certain embodiments, a substrate may have one (e.g., projection 214) or more (e.g., projection 218 and projection 220) projections on one side, may have projections on multiple sides (e.g., projection 218 and projection 224), may have projections with different shapes (e.g., projection 218 and 220), and/or may have projections with the same shape and different sizes (e.g., projection 222).

In certain embodiments, a projection may be composed of the same material as the substrate. For example, the projection may have been extruded (or formed using a suitable molding method) while forming the substrate. Additionally or alternatively, the projection may have been formed separately from the substrate and then bonded to the substrate.

FIG. 3 shows an illustrative schematic cross-sectional view of a structure of a stacked bi-polar ESD. Stack 300 includes three cell segments (e.g., corresponding to cell segment 212a, cell segment 212b, and cell segment 212c of FIG. 2), including cell segment 390. Each cell segment includes a positive active material electrode layer (e.g., active material 340a and 340b), a negative active material electrode layer (e.g., active material 360), and is bounded by a hardstop (e.g., hardstop 370), and two substrates (e.g., substrate 330 and substrate 380).

In this embodiment, a pressure equalization valve 310 is located in projection 320 and mitigates the pressure differentials between adjacent cells. For example, pressure equalization valve 310 allows gases to transfer between cell segment 390 and an adjacent cell segment 392 to mitigate any pressure differentials between the cell segments. Pressure equalization valve 310 is also hydrophobic and, therefore, prevents the electrolyte from passing through substrate 380.

In this embodiment, projection 320, featuring pressure equalization valve 310, is offset in both a direction normal to substrate 380 (i.e. extending from substrate 380) and normal to hardstop 370 (i.e. translated on substrate 380 towards center point 308). For example, by extending from the substrate, projection 320 is offset from the substrate in a direction along arrow 302. In addition, due to its location at the end of projection 320, pressure equalization valve 310 is also offset from the substrate in a direction along arrow 302, thus, preventing pressure equalization valve 310 from being submerged by free liquid when gravity causes free liquid to pool (e.g., as described below in relation to FIG. 4). Projection 320 is also offset in the direction normal from hardstop 370 and/or the center of cell segment 390 along arrow 304, thus, preventing pressure equalization valve 310 from being submerged by free liquid when gravity causes free liquid to pool (e.g., as described below in relation to FIG. 5). By offsetting projection 320, the apparatus ensures that any pressure differentials between cell segment 390 and an adjacent cell are mitigated even in the presence of free liquid.

For example, during normal operation, pressure equalization valve 310 associated with substrate 380 may allow gas to transfer between cell segment 390 and an adjacent cell. However, in some circumstances, free liquid may develop in cell segment 390 from the electrolyte. Furthermore, if the free liquid submerges pressure equalization valve 310, the gas may not be able to traverse substrate 380. Accordingly, pressure equalization valve 310 (and projection 320) is offset in multiple directions (as described in detail in relation to FIGS. 4-5 below), which prevents pressure equalization valve 310 from being submerged by free liquid when the ESD is in various orientations.

FIG. 3 also includes projection 382 located on substrate 306 and connecting at area 386a and area 386b. In FIG. 3, projection 382 and substrate 306 are shown as having substantially the same thickness. In some embodiments, projection 382 and substrate 306 may have varying thicknesses. For example, in some embodiments, the thickness of projection 382 may vary as projection 382 extends away from substrate 306 (e.g., in a direction along arrow 302). In some embodiments, substrate 306 and projection 382 may be formed of the same electrically conductive material. As explained below, in some embodiments, projection 382 may integrally formed when substrate 306 is formed. For example, substrate 306 and projection 382 may be formed together via a single mold. Alternatively, substrate 306 and projection 382 may be formed separately and be bonded together.

Projection 382 has a base portion (e.g., defined by a line connecting area 386c and area 386d). Projection 382 also includes a first leg (e.g., defined by a line connecting area 386b and area 386c) and a second leg (e.g., defined by a line connecting area 386a and area 386d). In FIG. 3, the first leg and second leg are shown sloping at substantially the same angle (relative to substrate 306) as they extend from substrate 306. It should be noted that in some embodiments the first leg and second leg may slope at different angles as they extend from substrate 306. In addition, in FIG. 3, the first leg and second leg are also shown sloping at substantially the same rate (relative to substrate 306) along the length of the first leg and second leg, respectively. It should be noted that in some embodiments, the first leg and the second leg may slope at varying rates (e.g., the first leg and the second leg may have step-like configurations). The slope of the first leg and the second leg of projection 382 give projection 382 a first circumference (e.g., with a diameter equal to the distance between area 386a and 386b) and a second circumference (e.g., with a diameter equal to the distance between area 386d and area 386c). In some embodiments, the first leg and the second leg may not slope resulting in the first circumference equaling the second circumference.

Projection 382 is fitted with pressure equalization valve 388. Pressure equalization valve 388 is centered on the base portion of projection 382 (e.g., defined by a line connecting area 386c and area 386d). In FIG. 3, the base portion of projection 382 is substantially parallel to substrate 306, both of which are substantially flat. It should be noted, however, that in some embodiments, neither the base portion of projection 382 nor substrate 306 may be flat. For example, one or more of the base portion of projection 382 and substrate 306 may curve or have other variations in slope along their respective length. Additionally, area 386a and area 386b may, in some embodiments, be located at different heights relative to each other. Likewise, in some embodiments, area 386c and area 386d may additionally or alternatively be located at different heights relative to each other. It should be noted in such cases, the first leg (e.g., defined by a line connecting area 386b and area 386c) and the second leg (e.g., defined by a line connecting area 386a and area 386d) may have differing lengths relative to each other.

Projection 382 extends a threshold distance from substrate 306, which corresponds to distance 384a. As used to herein, a “threshold distance” refers the closest distance (e.g., in millimeters) between the pressure equalization valve and a point of reference (e.g., a substrate, hardstop, center point, etc.) such that the pressure equalization valve is not submerged even in the presence of free liquid. For example, extending projection 382 a threshold distance from substrate 306 ensures that even if gravity causes free liquid to pool (e.g., as described below in relation to FIG. 4), pressure equalization valve 388 will not be submerged. In some embodiments, the threshold distance may be computed based on one or more other dimensions associated with the ESD (e.g., the volume of electrolyte in a cell segment (e.g., cell segment 212a of FIG. 2). Furthermore, the threshold distance may include any distance obtainable within the confines of the cell. For example, in some embodiments, a projection may extend to substantially the entire length/height of a cell.

In some embodiments, the threshold distance may be based relative to a component other than substrate 306. For example, a threshold distance may be determined based on a distance from hardstop 370, center point 308, active material 340b, etc. Furthermore, the threshold distance may be based at least in part on a distance between two components other than projection 320. For example, the threshold distance may be based on the height of active material 374 above a substrate (e.g., substrate 380). It should be noted that the height of an active material (e.g., active material 374) within a cell may vary. For example, the height of an active material may be less than the height of an associated projection (e.g., active material 340a), may be greater than the height of an associated projection (e.g., active material 374), or may vary such that portions of the active material have a height less than the height of an associated projection and greater than the height of an associated projection (e.g., active material 350).

Furthermore, in some embodiments, the location of an active material may vary between cells. For example, in some embodiments, active material may be found on substantially the entire surface area of a substrate (e.g., substrate 380) and/or a projection (e.g., projection 382). Alternatively, active material may be found only on particular portions of the surface area of a substrate. In some embodiments, the location of active material on a substrate may depend on the location of a projection on the substrate. For example, active material may be located only on one side of a projection (e.g., active material 374) or may be found on both sides of a projection (e.g., active material 340a and active material 340b). Furthermore, the negative active material electrode layer (e.g., active material 360) and the positive active material electrode layer (e.g., active material 340a and active material 340b) may be located on the same or different portions of their relative substrates (e.g., substrate 330 and substrate 380) in a cell segment (e.g., cell segment 390).

Projection 382 is located a first threshold distance (e.g., corresponding to distance 384b) from hardstop 372 and a second threshold distance from center point 308 (e.g., corresponding to distance 384c). Projection 382 is also located a third threshold distance from active material 374 (e.g., corresponding to distance 384d). It should be noted that in some embodiments, a single projection may be located threshold distances from various components of an ESD (e.g., center point 308, active material 374, and/or hardstop 372), including threshold distances from components on multiple sides of a single projection (e.g., active material 340a and active material 340b). As explained above and below, locating projection 382 (and consequently pressure equalization valve 388) a threshold distance from substrate 306 and/or a threshold distance from hardstop 372 (e.g., an inner boundary), center point 308, and/or active material 374 allows for pressure differentials between cells in an ESD to be mitigated by preventing pressure equalization valve 388 from being submerged by free liquid when the ESD is in multiple orientations.

FIG. 4 shows an illustrative schematic cross-sectional view of a BPU featuring projection and a pressure equalization valve in a first orientation. As shown by apparatus 400, despite the presence of free liquid 450 in electrolyte 440, the pressure equalization valve 410 is not submerged by free liquid 450.

When the ESD is oriented in a first position, offsetting pressure equalization valve 410 normal to the substrate (e.g., by situating pressure equalization valve 410 on projection 420) ensures that pressure equalization valve 410 is not submerged by free liquid 450. For example, when oriented in the first position (e.g., upright), gravity may cause free liquid 450 to pool about the circumference of projection 420 as projection 420 extends in a direction normal to substrate 430 along arrow 460. The height (e.g., between 0.025 and 5 millimeters or greater) of projection 420 ensures that pressure equalization valve 410, located at the end of projection 420, is above the liquid level of the free liquid 450.

Locating a pressure equalization valve (e.g., pressure equalization valve 410) on a projection (e.g., projection 420) ensures that the pressure equalization valve is a threshold distance from the substrate. The threshold distance associated with a cell segment may depend on numerous factors including, but not limited to, any size and/or dimension associated with any portion or component of the ESD, BPU and/or cell segment, the volume of electrolyte in a cell segment, and/or the composition of the electrolyte and/or any other component of the ESD.

FIG. 5 shows an illustrative schematic cross-sectional view of a BPU featuring a projection and a pressure equalization valve in a second orientation. As shown by apparatus 500, despite the presence of free liquid 560 in electrolyte 540, the pressure equalization valve 510 is not submerged by free liquid 560.

For example, when the ESD is oriented in a second position (e.g., perpendicular to the first position), offsetting pressure equalization valve 510 in a direction normal to hardstop 550 along arrow 570 ensures pressure differentials are mitigated. For example, when oriented in the second position (e.g., sideways), gravity may cause the free liquid 560 to pool in the direction parallel to the one in which projection 520 extends, negating any advantage the height of projection 520 from substrate 530 provided. To ensure that pressure equalization valve 510 is above the liquid level of the free liquid 560 in the second position, pressure equalization valve 510 may be offset in a direction parallel to the liquid level of the free liquid 560. The offset of pressure equalization valve 510 (and projection 520) in the direction along arrow 570 (e.g., away from hardstop 550) ensures that pressure equalization valve 510, located at the end of projection 520, is above the liquid level of the free liquid 520.

Offsetting a pressure equalization valve (e.g., pressure equalization valve 510) from the inner boundaries (e.g., hardstop 550) of a cell segment ensures that the pressure equalization valve is not submerged by free liquid (e.g., free liquid 560). In this embodiment, pressure equalization valve 510 (and projection 520) are located a threshold distance from hardstop 550. Additionally or alternatively, the pressure equalization valve 510 (and projection 520) may be located a threshold distance from the active material on the substrate. The threshold distance associated with a cell segment may depend on numerous factors including, but not limited to, any size and/or dimension associated with any portion or component of the ESD, BPU and/or cell segment, the volume of electrolyte in a cell segment, and/or the composition of the electrolyte and/or any other component of the ESD.

As discussed above, projections may include various shapes, sizes, and orientations. FIGS. 6-8 represent examples of projections with these varying shapes, sizes, and orientations, which may be incorporated into one or more of the embodiments herein. It should be noted that the projections of FIGS. 6-8 are illustrative only and should not be taken as limiting in any manner.

FIG. 6 shows an illustrative schematic view of a projection and a pressure equalization valve featuring a conical shape. Projection 600 includes first face 620, second face 630, and aperture 640, which receives pressure equalization valve 610. Projection 600 is a conically shaped projection. For example, second face 630 is bounded by a substrate (e.g., substrate 206 of FIG. 2) and first face 620. As projection 600 is conical, projection 600 has a circular area that may connect to substrate (e.g., substrate 530 of FIG. 5).

First face 620 is parallel to a substrate upon which projection 600 is located. In certain embodiments, first face 620 may be a threshold distance from the substrate. For example, gravity may cause free liquid to pool about the circumference of projection 600; however, the height of projection 600 (e.g., corresponding to a threshold distance) ensures that pressure equalization valve 610 is above the liquid level of the free liquid.

First face 620 also includes pressure equalization valve 610 located within aperture 640. Aperture 640 is currently shown as a circle (or cylinder); however, it should be noted that aperture 640 may include any shape. Aperture 640 may extend to the substrate upon which projection 600 is located (e.g., corresponding to the threshold distance) or, if projection 600 is hollow, aperture 640 may only extend through projection 600 (e.g., corresponding to less than the threshold distance).

Pressure equalization valve 610 is located within aperture 640. Pressure equalization valve 610 may or may not extend the entire length of aperture 640. For example, pressure equalization valve 610 may fill only a partial amount of the volume of aperture 640.

FIG. 7 shows an illustrative schematic view of a projection and a pressure equalization valve featuring a polyhedral shape. Projection 700 includes first face 720, second face 730, and aperture 740, which receives pressure equalization valve 710. Projection 700 has a polyhedral shape. For example, second face 730 is bounded by a substrate (e.g., substrate 206 of FIG. 2) and first face 720. As projection 700 has a polyhedral shape, projection 700 has a polygonal area that may connect to substrate (e.g., substrate 430 of FIG. 4). For example, the connection area between projection 700 and a substrate upon which it is attached may have a first length in a first direction along the substrate and a second length, which may be different than the first length, in a second direction along the substrate.

First face 720 is substantially parallel to a substrate upon which projection 700 is located. It should be noted, however, that in certain embodiments first face 720 may not be substantially parallel to a substrate upon which projection 700 is located. For example, the height of a point on first face 720 (relative to the substrate) may vary depending on the location of the point on first face 720.

First face 720 also includes pressure equalization valve 710 located within aperture 740. Aperture 740 is currently shown as a rectangle (or polyhedral); however, it should be noted that aperture 740 may include any shape. For example, the shape and distance from the substrate of first face 720 and aperture 740 may vary depending on the distance from either the boundaries (e.g., hardstop 550 of FIG. 5) or center point of the cell segment (e.g., cell segment 212a, 212b, and 212c of FIG. 2) within which projection 700 is located.

Pressure equalization valve 710 is located within aperture 740. Pressure equalization valve 710 may or may not extend the entire length of aperture 740. For example, pressure equalization valve 710 may fill only a partial amount of the volume of aperture 740. For example, the volume of pressure equalization valve 710 may vary depending on the distance from either the boundaries (e.g., hardstop 550 of FIG. 5) or center point of the cell segment (e.g., cell segment 212a, 212b, and 212c of FIG. 2) within which projection 700 is located.

FIG. 8 shows a schematic view of a projection and a plurality of pressure equalization valves according to certain embodiments. Projection 800 includes a plurality of pressure equalization valves (e.g., pressure equalization valve 810 and pressure equalization valve 820) within a plurality of apertures (e.g., aperture 840 and aperture 850, respectively) on first face 830. Projection 800 is a conically shaped projection. For example, first face 830 is bounded by a substrate (e.g., substrate 206 of FIG. 2) upon which projection 800 is located.

Pressure equalization valve 810 is located within aperture 840. Likewise, pressure equalization valve 820 is located within aperture 850. Aperture 840 and aperture 850 are currently shown as circles (or cylinders) of the same size; however, it should be noted that aperture 840 and aperture 850 may include any shape and/or size. In certain embodiments, the shape and/or size of aperture 840 and aperture 850 may depend on the distance to the substrate from their location on first face 830. For example, the size of aperture 840 may be larger (e.g., ranging from 10 microns to 100 microns) than the size of aperture 850 (e.g., ranging from 1 micron to 10 microns) because aperture 840 has a greater threshold distance from the substrate than aperture 850.

In certain embodiments, the shape and/or size of aperture 840 and aperture 850 may depend on a threshold distance. For example, the size of aperture 840 may be larger than the size of aperture 850 because aperture 840 has a greater threshold distance from either the boundaries (e.g., hardstop 550 of FIG. 5) or center point of the cell segment (e.g., cell segment 212a, 212b, and 212c of FIG. 2) within which projection 800 is located than aperture 850. Additionally or alternatively aperture 840 and aperture 850 may be arranged on projection 800 in a variety or orders or arrangements. For example, aperture 840 and aperture 850 may be arrange in series in the direction in which projection 800 extends.

FIG. 9 shows a schematic cross-sectional view of an illustrative structure of a stacked bi-polar ESD, in which a pressure equalization valve is located in a through hole of a hardstop. For example, in some embodiments, a pressure equalization valve may be located remotely from the substrate. In such cases, a hydrophobic pressure equalization valve located within a through hole of the hardstop may allow gas to transfer between adjacent cells to mitigate any pressure differentials between the adjacent cells, while preventing the electrolyte from also flowing to an adjacent cell.

FIG. 9 shows stack 900. Stack 900 includes gasket 902, hardstop 904, substrate 906, through hole 908, and pressure equalization valve 910 within through hole 908. Gasket 902 is interfaced with hardstop 904 to form a first boundary of a cell segment, which is capped on either end by a substrate (e.g., substrate 906). Furthermore, in some embodiments, substrate 906 and hardstop 904 may be co-molded. In addition, hardstop 904 includes through hole 908, which penetrates the length of hardstop 904 along a direction indicated by arrow 916. Through hole 908 may have a diameter between 1 micron and 10000 microns.

To mitigate any pressure differentials between the adjacent cells, gases may flow around substrate 906 via pressure equalization valve 910 in through hole 908. For example, as indicated by arrow 914, gases may flow from an adjacent cell segment into through hole 908. After traversing pressure equalization valve 910, gases may flow out of through hole 908 as indicated by arrow 912. It should be noted that arrow 912 and arrow 914, and the direction associated with each, is but an illustrative course that gases may take when traversing pressure equalization valve 910. Gases may as equally flow in the opposite direction associated with arrow 912 and arrow 914, respectively.

The substrates used to form the BPUs described herein (e.g., substrate 206 of FIG. 2, substrate 380 of FIG. 3, etc.) may be formed of any suitable conductive and impermeable or substantially impermeable material, including, but not limited to, a non-perforated metal foil, aluminum foil, stainless steel foil, cladding material including nickel and aluminum, cladding material including copper and aluminum, nickel plated steel, nickel plated copper, nickel plated aluminum, gold, silver, any other suitable material, or combinations thereof, for example. Each substrate may be made of two or more sheets of metal foils adhered to one another, in certain embodiments. The substrate of each BPU may typically be between 0.025 and 5 millimeters thick, while the substrate of each MPU may be between 0.025 and 10 millimeters thick and act as terminals to the ESD, for example. Metalized foam, for example, may be combined with any suitable substrate material in a flat metal film or foil, for example, such that resistance between active materials of a cell segment may be reduced by expanding the conductive matrix throughout the electrode.

The positive electrode layers (e.g., positive active material electrode layer 102 of FIG. 1) provided on these substrates to form the BPUs may be formed of any suitable active material, including, but not limited to, nickel hydroxide (Ni(OH)₂), zinc (Zn), any other suitable material, or combinations thereof, for example. The positive active material may be sintered and impregnated, coated with an aqueous binder and pressed, coated with an organic binder and pressed, or contained by any other suitable technique for containing the positive active material with other supporting chemicals in a conductive matrix. The positive electrode layer of the electrode unit may have particles, including, but not limited to, metal hydride (MH), palladium (Pd), silver (Ag), any other suitable material, or combinations thereof, infused in its matrix to reduce swelling, for example. This may increase cycle life, improve recombination, and reduce pressure within the cell segment, for example. These particles, such as MH, may also be in a bonding of the active material paste, such as Ni(OH)₂, to improve the electrical conductivity within the electrode and to support recombination.

The negative electrode layers (e.g., negative active material electrode layer 104 of FIG. 1) provided on these substrates to form the electrode units of the BPUs may be formed of any suitable active material, including, but not limited to, MH, Cd, Mn, Ag, or any other suitable material, or combinations thereof, for example. The negative active material may be sintered, coated with an aqueous binder and pressed, coated with an organic binder and pressed, or contained by any other suitable technique for containing the negative active material with other supporting chemicals in a conductive matrix, for example. The negative electrode side may have chemicals including, but not limited to, Ni, Zn, Al, any other suitable material, or combinations thereof, infused within the negative electrode material matrix to stabilize the structure, reduce oxidation, and extend cycle life, for example.

Various suitable binders, including, but not limited to, organic carboxymethylcellulose (CMC) binder, Creyton rubber, PTFE (Teflon), any other suitable material, or combinations thereof, for example, may be mixed with the active material layers to hold the layers to their substrates. Ultra-still binders, such as 200 ppi metal foam, may also be used with the stacked ESD constructions.

The common collector or electronic raceway used to form the active material electrode layers may be formed of any suitable conductive and impermeable or substantially impermeable material, including, but not limited to, a non-perforated metal foil, aluminum foil, stainless steel foil, cladding material including nickel and aluminum, cladding material including copper and aluminum, nickel plated steel, nickel plated copper, nickel plated aluminum, gold, silver, any other suitable conductive and/or mechanically durable material, or combinations thereof. For example, each electronic raceway may be made of two or more sheets of metal foils adhered to one another. The electronic raceway may have a relatively high mechanical strength in order to resist potentially negative stress-effects from folding.

The separator of each electrolyte layer of the ESD may be formed of any suitable material that electrically isolates its two adjacent electrode units while allowing ionic transfer between those electrode units. The separator may contain cellulose super absorbers to improve filling and act as an electrolyte reservoir to increase cycle life, wherein the separator may be made of a polyabsorb diaper material, for example. The separator may, thereby, release previously absorbed electrolyte when charge is applied to the ESD. In certain embodiments, the separator may be of a lower density and thicker than normal cells so that the inter-electrode spacing (IES) may start higher than normal and be continually reduced to maintain the capacity (or C-rate) of the ESD over its life as well as to extend the life of the ESD.

The separator may be a relatively thin material bonded to the surface of the active material on the electrode units to reduce shorting and improve recombination. This separator material may be sprayed on, coated on, pressed on, or combinations thereof, for example. The separator may have a recombination agent attached thereto, in certain embodiments. This agent may be infused within the structure of the separator (e.g., this may be done by physically trapping the agent in a wet process using a polyvinyl alcohol (PVA or PVOH) to bind the agent to the separator fibers, or the agent may be put therein by electro-deposition), or it may be layered on the surface by vapor deposition, for example. The separator may be made of any suitable material or agent that effectively supports recombination, including, but not limited to, Pb, Ag, any other suitable material, or combinations thereof, for example. While the separator may present a resistance if the substrates of a cell move toward each other, a separator may not be provided in certain embodiments that may utilize substrates stiff enough not to deflect.

The electrolyte of each electrolyte layer of the ESD may be formed of any suitable chemical compound that may ionize when dissolved or molten to produce an electrically conductive medium. The electrolyte may be a standard electrolyte of any suitable chemical, including, but not limited to, NiMH, for example. The electrolyte may contain additional chemicals, including, but not limited to, lithium hydroxide (LiOH), sodium hydroxide (NaOH), calcium hydroxide (CaOH), potassium hydroxide (KOH), any other suitable material, or combinations thereof, for example. The electrolyte may also contain additives to improve recombination, such as, but not limited to, Ag(OH)₂, for example. The electrolyte may also contain rubidium hydroxide (RbOH), for example, to improve low temperature performance. Additionally or alternatively, the electrolyte may be frozen within the separator and then thawed after the ESD is completely assembled. This may allow for particularly viscous electrolytes to be inserted into the electrode unit stack of the ESD before the seals have formed substantially fluid tight seals with the electrode units adjacent thereto.

The seals and gaskets (e.g., gasket 902 of FIG. 9) of the ESD (which in some embodiments may be interfaced with a substrate) may be formed of any suitable material or combination of materials that may effectively seal an electrolyte within the space (e.g., forming an inner boundary) defined by the seal and the electrode units adjacent thereto. In certain embodiments, the seals and gaskets may be formed from a solid seal barrier or loop, or multiple loop portions capable of forming a solid seal loop, that may be made of any suitable nonconductive material, including, but not limited to, nylon, polypropylene, cell gard, rubber, PVOH, any other suitable material, or combinations thereof, for example. A seal and/or gasket formed from a solid seal barrier may contact a portion of an adjacent electrode to create a seal therebetween.

Alternatively, the seals and gaskets may be formed from any suitable viscous material or paste, including, but not limited to, epoxy, brea tar, electrolyte (e.g., KOH) impervious glue, compressible adhesives (e.g., two-part polymers, such as Loctite® brand adhesives made available by the Henkel Corporation, that may be formed from silicon, acrylic, and/or fiber reinforced plastics (FRPs) and that may be impervious to electrolytes), any other suitable material, or combinations thereof, for example. A seal or gasket formed from a viscous material may contact a portion of an adjacent electrode to create a seal therebetween. In yet other embodiments, a seal or gasket may be formed by a combination of a solid seal loop and a viscous material, such that the viscous material may improve sealing between the solid seal loop and an adjacent electrode unit. Alternatively or additionally, an electrode unit itself may be treated with viscous material before a solid seal loop, a solid seal loop treated with additional viscous material, an adjacent electrode unit, or an adjacent electrode unit treated with additional viscous material, is sealed thereto, for example.

Moreover, alternatively or additionally, a seal or gasket between adjacent electrode units may be provided with one or more weak points that may allow certain types of fluids (i.e., certain liquids or gasses) to escape therethrough (e.g., if the internal pressures in the cell segment defined by that seal increases past a certain threshold). Once a certain amount of fluid escapes or the internal pressure decreases, the weak point may reseal. A seal formed at least partially by certain types of suitable viscous material or paste, such as brai, may be configured or prepared to allow certain fluids to pass therethrough and configured or prepared to prevent other certain fluids to pass therethrough. Such a seal may prevent any electrolyte from being shared between two cell segments that may cause the voltage and energy of the ESD to fade (i.e., discharge) quickly to zero.

Hardstops (e.g., hardstop 372 of FIG. 3) may be formed of any suitable material including, but not limited to, various polymers (e.g., polyethylene, polypropylene), ceramics (e.g., alumina, silica), any other suitable mechanically durable and/or chemically inert material, or combinations thereof. The hardstop material or materials may be selected, for example, to withstand various ESD chemistries that may be used. Furthermore, hardstop may be used in conjunction with one or more seals and/or gaskets to contain electrolyte in a cell segment (e.g., cell segment 212a of FIG. 2) as shown in FIG. 9 above.

As mentioned above, one benefit of utilizing ESDs designed with sealed cells in a stacked formation may be an increased discharge rate of the ESD. This increased discharge rate may allow for the use of certain less-corrosive electrolytes (e.g., by removing or reducing the whetting, conductivity enhancing, and/or chemically reactive component or components of the electrolyte) that otherwise might not be feasible in prismatic or wound ESD designs. This leeway that may be provided by the stacked ESD design to use less-corrosive electrolytes may allow for certain epoxies (e.g., J-B Weld epoxy) to be utilized when forming a seal with gaskets that may otherwise be corroded by more-corrosive electrolytes.

The case or wrapper of an ESD may be formed of any suitable nonconductive material that may seal to the terminal electrode units for exposing their conductive substrates or their associated leads. The wrapper may also be formed to create, support, and/or maintain the seals between the gaskets and the electrode units adjacent thereto for isolating the electrolytes within their respective cell segments. The wrapper may create and/or maintain the support required for these seals such that the seals may resist expansion of the ESD as the internal pressures in the cell segments increase. The wrapper may be made of any suitable material, including, but not limited to, nylon, any other polymer or elastic material, including reinforced composites, nitrile rubber, or polysulfone, or shrink wrap material, or any rigid material, such as enamel coated steel or any other metal, or any insulating material, any other suitable material, or combinations thereof, for example. In certain embodiments, the wrapper may be formed by an exoskeleton of tension clips, for example, that may maintain continuous pressure on the seals of the stacked cells. A non-conductive barrier may be provided between the stack and wrapper to prevent the ESD from shorting.

With reference to FIG. 2, for example, stack 200 may include a plurality of cell segments (e.g., cell segment 212a, cell segment 212b, and cell segment 212c) formed by MPUs and the stack of one or more BPUs therebetween. In accordance with certain embodiments, the thicknesses and materials of each one of the substrates (e.g., substrate 206 of FIG. 2), the electrode layers (e.g., positive electrode layer 204 of FIG. 2), and negative electrode layer 208 of FIG. 2), and the electrolyte layer (e.g., electrolyte layer 210 of FIG. 2) may differ from one another, not only from cell segment to cell segment, but also within a particular cell segment. This variation of geometries and chemistries, not only at the stack level, but also at the individual cell level, may create ESDs with various benefits and performance characteristics.

Additionally, the materials and geometries of the substrates, electrode layers, electrolyte layers, gaskets and hardstops may vary along the height of the stack from cell segment to cell segment. With further reference to FIG. 2, for example, the electrolyte used in each of the electrolyte layer 210 may vary based upon how close its respective cell segment (e.g., cell segment 212a, cell segment 212b, or cell segment 212c) is to the middle of the stack of cell segments. For example, an innermost cell segment may include an electrolyte layer that is formed of a first electrolyte, while middle cell segments may include electrolyte layers that are each formed of a second electrolyte, while outermost cell segments may include electrolyte layers that are each formed of a third electrolyte. By using higher conductivity electrolytes in the internal stacks, the resistance may be lower such that the heat generated may be less. This may provide thermal control to the ESD by design instead of by external cooling techniques.

As another example, the active materials used as electrode layers in each of the cell segments may also vary based upon how close its respective cell segment is to the middle of the stack of cell segments. For example, innermost cell segment may include electrode layers formed of a first type of active materials having a first temperature and/or rate performance, while middle cell segments may include electrode layers formed of a second type of active materials having a second temperature and/or rate performance, while outermost cell segments may include electrode layers formed of a third type of active materials having a third temperature and/or rate performance. As an example, an ESD stack may be thermally managed by constructing the innermost cell segments with electrodes of nickel cadmium, which may better absorb heat, while the outermost cell segments may be provided with electrodes of nickel metal hydride, which may need to be cooler, for example. Alternatively, the chemistries or geometries of the ESD may be asymmetric, where the cell segments at one end of the stack may be made of a first active material and a first height, while the cell segments at the other end of the stack may be of a second active material and a second height.

Moreover, the geometries of each of the cell segments may also vary along the stack of cell segments. Besides varying the distance between active materials within a particular cell segment, certain cell segments may have a first distance between the active materials of those segments, while other cell segments may have a second distance between the active materials of those segments. In any event, the cell segments or portions thereof having smaller distances between active material electrode layers may have higher power, for example, while the cell segments or portions thereof having larger distances between active material electrode layers may have more room for dendrite growth, longer cycle life, and/or more electrolyte reserve, for example. These portions with larger distances between active material electrode layers may regulate the charge acceptance of the ESD to ensure that the portions with smaller distances between active material electrode layers may charge first, for example.

In an embodiment, the geometries of the electrode layers may vary along the radial length of substrates. With respect to FIG. 2, the electrode layers are of uniform thickness and are symmetric about the electrode shape. Additionally or alternatively, the electrode layers may be non-uniform. For example, the positive active material electrode layer and negative active material electrode layer thicknesses may vary with radial position on the surface of the conductive substrate. Non-uniform electrode layers are discussed in more detail in West et al. U.S. patent application Ser. No. 12/258,854, which, as stated above, is hereby incorporated by reference herein in its entirety.

Although each of the above described and illustrated embodiments of a stacked ESD show a cell segment including a gasket sealed to each of a first and second electrode unit for sealing an electrolyte therein, it should be noted that each electrode unit of a cell segment may be sealed to its own gasket, and the gaskets of two adjacent electrodes may then be sealed to each other for creating the sealed cell segment.

In certain embodiments, a gasket may be injection molded to an electrode unit or another gasket such that they may be fused together to create a seal. In certain embodiments, a gasket may be ultrasonically welded to an electrode unit or another gasket such that they may together form a seal. In other embodiments, a gasket may be thermally fused to an electrode unit or another gasket, or through heat flow, whereby a gasket or electrode unit may be heated to melt into another gasket or electrode unit. Moreover, in certain embodiments, instead of or in addition to creating groove shaped portions in surfaces of gaskets and/or electrode units to create a seal, a gasket and/or electrode unit may be perforated or have one or more holes running through one or more portions thereof. Alternatively, a hole or passageway or perforation may be provided through a portion of a gasket such that a portion of an electrode unit (e.g., a substrate) may mold to and through the gasket. In yet other embodiments, holes may be made through both the gasket and electrode unit, such that each of the gasket and electrode unit may mold to and through the other of the gasket and electrode unit, for example.

Although each of the above described and illustrated embodiments of the stacked ESD show an ESD formed by stacking substrates having substantially round cross-sections into a cylindrical ESD, it should be noted that any of a wide variety of shapes may be utilized to form the substrates of the stacked ESD. For example, the stacked ESD may be formed by stacking electrode units having substrates with cross-sectional areas that are rectangular, triangular, hexagonal, or any other desired shape or combination thereof.

It will be understood that the foregoing is only illustrative of the principles of the disclosure, and that various modifications may be made by those skilled in the art without departing from the scope and spirit of this disclosure. It will also be understood that various directional and orientational terms such as “horizontal” and “vertical,” “top” and “bottom” and “side,” “length” and “width” and “height” and “thickness,” “inner” and “outer,” “internal” and “external,” and the like are used herein only for convenience, and that no fixed or absolute directional or orientational limitations are intended by the use of these words. For example, the devices of this disclosure, as well as their individual components, may have any desired orientation. If reoriented, different directional or orientational terms may need to be used in their description, but that will not alter their fundamental nature as within the scope and spirit of this disclosure. Those skilled in the art will appreciate that the disclosure may be practiced by other than the described embodiments, which are presented for purposes of illustration rather than of limitation, and the disclosure is limited only by the claims that follow.

1. A system for mitigating pressure differentials between cells in an energy storage device, the system comprising:
a substrate;
a projection extending from the substrate; and
a pressure equalization valve, located at the projection, a threshold distance from the substrate.

2. The system of claim 1, wherein the threshold distance is such that the pressure equalization valve located at the projection is not submerged by free liquid while the energy storage device is in a first position.

3. The system of claim 1, further comprising an active material, wherein the projection is offset from the active material.

4. The system of claim 1, further comprising a hardstop, wherein the projection is offset from the hardstop.

5. The system of claim 4, wherein the projection is offset from the hardstop a threshold distance.

6. The system of claim 5, wherein the threshold distance the projection is offset from the hardstop is such that the pressure equalization valve located at the projection is not submerged by free liquid while the energy storage device is in a second position.

7. The system of claim 1, further comprising a hydrophobic element located at the pressure equalization valve.

8. The system of claim 1, wherein the projection has a conical shape.

9. The system of claim 1, wherein the pressure equalization valve is located at a surface of the projection that is substantially parallel to the substrate.

10. The system of claim 1, further comprising a connection area between the projection and the substrate, wherein the connection area has a first length in a first direction along the substrate and a second length in a second direction along the substrate, and wherein the first length is different than the second length.

11. The system of claim 1, further comprising an aperture located at the projection for receiving the pressure equalization valve.

12. The system of claim 11, wherein the aperture has a diameter between 1 micron and 100 microns.

13. The system of claim 11, wherein the aperture has a diameter between 1 micron and 10000 microns.

14. A method for mitigating pressure differentials between cells in an energy storage device, the method comprising:
allowing gas to transfer between adjacent cells through a pressure equalization valve located at a projection located at a substrate; and
preventing a liquid level from submerging the pressure equalization valve located a threshold distance from the substrate.

15. The method of claim 14, further comprising containing the gas at least in part by a boundary, wherein the projection is offset from the boundary.

16. The method of claim 15, wherein the projection is offset from the boundary a threshold distance.

17. The method of claim 16, wherein the threshold distance the projection is offset from the boundary is such that the pressure equalization valve located at the projection is not submerged by free liquid while the energy storage device is in a second position.

18. The method of claim 14, further comprising preventing electrolyte from transferring through the pressure equalization valve.

19. The method of claim 14, further comprising allowing the gas traverse the substrate though an aperture located at the projection for receiving the pressure equalization valve.

20. The method of claim 19, wherein the aperture has a diameter between 1 micron and 10000 microns.

21-33. (canceled)
